(19) United States
(12) Patent Application Publication
(10) Pub. No.: US 2026/0037187 A1
(43) Pub. Date: Feb. 5, 2026

(54) STATUS INDICATIONS FOR STORING DATA TO A MEMORY SYSTEM VIA COMMAND HEADERS

(71) Applicant: Micron Technology, Inc., Boise, ID (US)

(72) Inventors: Lei Pan, Shanghai (CN); Hui Wang, Shanghai (CN)

(21) Appl. No.: 19/274,336

(22) Filed: Jul. 18, 2025

Related U.S. Application Data
(60) Provisional application No. 63/677,713, filed on Jul. 31, 2024.

(51) Int. Cl. G06F 3/06

(52) U.S. Cl. CPC G06F 3/0659; G06F 3/0611; G06F 3/0616; G06F 3/0688

(57) ABSTRACT

Methods, systems, and devices for status indications for storing data to a memory system via command headers are described. The described techniques provide for a host system to utilize initiator identifier (IID) and extended IID (EXT_IID) fields of a write command to indicate storage information for storing data. The host system may indicate a host process via a first set of one or more bits of the storage information, which may support the memory system identifying a storage location for storing the data. Additionally, the host system may indicate a storage configuration via a second set of one or more bits of the storage information, which may support the memory system identifying a type of memory for storing the data. For example, the storage configuration may indicate whether the data is high performance data, high-stress data, hot or cold data, or any combination thereof.

### CROSS REFERENCE

The present application for patent claims priority to U.S. Patent Application No. 63/677,713 by Pan et al., entitled “STATUS INDICATIONS FOR STORING DATA TO A MEMORY SYSTEM VIA COMMAND HEADERS,” filed Jul. 31, 2024, which is assigned to the assignee hereof, and which is expressly incorporated by reference in its entirety herein.

### TECHNICAL FIELD

The following relates to one or more systems for memory, including status indications for storing data to a memory system via command headers.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports status indications for storing data to a memory system via command headers in accordance with examples as disclosed herein.

FIG. 2 shows an example of a system that supports status indications for storing data to a memory system via command headers in accordance with examples as disclosed herein.

FIG. 3 shows a block diagram of a memory system that supports status indications for storing data to a memory system via command headers in accordance with examples as disclosed herein.

FIG. 4 shows a block diagram of a host system that supports status indications for storing data to a memory system via command headers in accordance with examples as disclosed herein.

FIGS. 5 and 6 show flowcharts illustrating methods that support status indications for storing data to a memory system via command headers in accordance with examples as disclosed herein.

### DETAILED DESCRIPTION

Memory systems may be provided in accordance with various configurations for storing data in response to one or more received commands. Some configurations may support a memory system receiving commands from a host system via an interface between the memory system and the host system, such as a universal flash storage (UFS) interface. For example, a host system may transmit a command associated with (e.g., corresponding to, accompanied by, included in, including) a UFS protocol information unit (UPIU) or other information structure that configures aspects of the command. In some cases, a UPIU structure may include one or more header segments (e.g., a first 12 bytes of the UPIU) and one or more data segments. The one or more header segments may convey information (e.g., configuration information, control information) associated with executing the command (e.g., associated with storing data included in the one or more data segments), which may include an initiator identifier (IID) field and an extended IID (EXT_IID) field, among other fields. In some implementations, IID and EXT_IID fields may support a host system indicating control information for one or more types of commands, such as task management commands. For example, IID and EXT_IID fields may provide a memory system with an identifier of an initiating device (e.g., a host system) that created the UPIU associated with a task management request. However, in some examples, IID and EXT_IID fields may be empty or unused (e.g., unallocated, not configured) for UPIUs associated with other types of commands, such as a UPIU that corresponds to a write command, which may result in inefficient utilization of UPIU header segments, thereby limiting data storage performance at a memory system.

Techniques described herein provide for a host system to utilize IID and EXT_IID fields of a UPIU associated with a write command to indicate information (e.g., storage information, command information, configuration information, control information, write configuration information) for storing data associated with the UPIU. For example, such storage information may support a memory system managing total bytes written (TBW) constraints, among others, associated with some implementation scenarios, such as in an automotive or other implementation where performance and data reliability constraints may be relatively stringent. In such implementations, IID and EXT_IID fields may each be associated with a set of bits within designated bytes of the UPIU header such that, together, the IID and EXT_IID correspond to 8 bits (a byte) that indicate command information. A host system may include a multi-command queue (MCQ) ID in a first set of one or more bits of the storage information, where the MCQ ID may indicate a host process associated with the UPIU, such as indicating a central processing unit (CPU) core of the host system associated with the UPIU. In some cases, an MCQ ID may support a memory system identifying a storage location for storing data included in the UPIU due, for example, to data associated with a given MCQ ID being managed within a similar region of memory in accordance with a locality principle.

In some implementations, storage information of a UPIU may indicate a storage configuration for storing data in a second set of one or more bits of the IID and EXT_IID fields, where the second set of one or more bits may include respective flags indicating a status of the data. For example, a high performance (HP) flag may be associated with (e.g., located in) a first bit of the second set of bits and may indicate whether the data is to be written to a single-level cell (SLC) cache. A stressful data (SD) flag may be associated with a second bit of the second set of bits and may indicate whether the data is to be written to a region associated with reduced write amplification or high endurance. A data cold (DC) flag may be associated with a third bit of the second set of bits and may indicate whether the data is hot data or cold data (e.g., indicating whether the data should be stored to blocks with relatively higher or lower program/erase cycle (PEC) counts). By utilizing the IID and EXT_IID fields of a UPIU associated with a write command to indicate storage configurations for storing data, performance of a memory system when executing the write command, or subsequent read commands or media management operations, may be improved (e.g., enabling the memory system to meet TBW constraints associated with an automotive usage scenario).

In addition to applicability in memory systems as described herein, techniques for status indications for storing data via command headers may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds and command header utilization, which may decrease processing or latency times, improve response times, or otherwise improve user experience, among other benefits.

Features of the disclosure are illustrated and described in the context of systems, devices, and circuits. Features of the disclosure are further illustrated and described in the context of flowcharts.

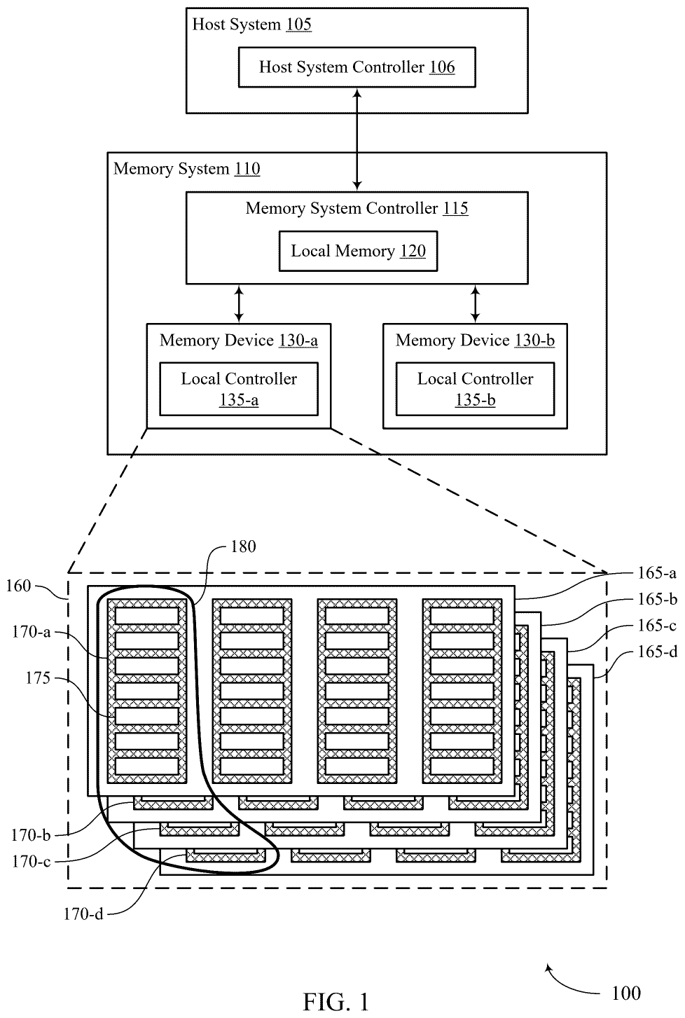

FIG. 1 shows an example of a system 100 that supports status indications for storing data to a memory system via command headers in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a UFS device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

A memory system 110 may receive commands from a host system 105 via an interface between the memory system 110 and the host system 105, such as a UFS interface. For example, a host system 105 may transmit a command associated with (e.g., corresponding to, accompanied by, included in, including) a UFS protocol information unit (UPIU) or other information structure that configures aspects of the command. In some cases, a UPIU structure may include one or more header segments (e.g., a first 12 bytes of the UPIU) and one or more data segments. The one or more header segments may convey information (e.g., configuration information, control information) associated with a memory system 110 responding to the command (e.g., associated with reading or writing data, associated with performing a media management operation), which may include an initiator identifier (IID) field and an extended IID (EXT_IID) field, among other fields. In some implementations, IID and EXT_IID fields may support a host system 105 indicating control information for one or more types of commands, such as task management commands. For example, IID and EXT_IID fields may provide a memory system 110 with an identifier of an initiating device (e.g., a host system 105) that created the UPIU associated with a task management request. However, in some examples, IID and EXT_IID fields may be empty or unused (e.g., unallocated, not configured) for UPIUs associated with other types of commands, such as a UPIU that corresponds to a write command, which may result in inefficient utilization of UPIU header segments, thereby limiting data storage performance at a memory system 110.

In some examples, a host system 105 may be configured to utilize IID and EXT_IID fields of a UPIU associated with a write command to indicate information (e.g., storage information, configuration information, control information, write configuration information) for storing data included in the UPIU. For example, such information may support a memory system 110 managing TBW constraints, among others, associated with some implementation scenarios, such as in an automotive implementation or other implementation where input/output (I/O) quality of service (QoS) is a key performance characteristic. For example, to log emergency record information when a critical traffic condition occurs (e.g., in black box usage), a host system 105 and a memory system 110 may be expected to flush data via a UFS interface relatively quickly (e.g., immediately). In such examples, satisfying UFS TBW constraints associated with a data stream implementation (e.g., an automotive stream recording usage model) may be challenging, for example, due to relatively large data sizes being written. In some cases, a host system 105 may enable features such as write boost to support satisfying the UFS TBW constraints when device performance or QoS is considered, where enablement of write boost may be toggled for different stream recording usages. However, when multiple applications are performed simultaneously in the system 100, the host system 105 may be unable to enable and disable write boost for different applications (e.g., for different host processes). Thus, utilizing the IID and EXT_IID fields of the UPIU to indicate the storage information may support enhancing data storage performance on a per-application basis (e.g., a per-process basis).

In some implementations, IID and EXT_IID fields may each be associated with a set of bits within designated bytes of the UPIU header such that, together, an IID field and an EXT_IID field may correspond to 8 bits (a byte) that indicate command information. For example, an IID field may correspond to four bits within a first byte of the UPIU header (e.g., bits [3:0] of byte 4 of the header) and an EXT_IID field may correspond to four bits within a second byte of the UPIU header (e.g., bits [7:4] of byte 7 of the header). A host system 105 may include an MCQ ID in a first set of one or more bits of the IID and EXT_IID fields, where the MCQ ID may indicate a host process associated with the UPIU (e.g., a CPU core of the host system 105 associated with the UPIU). In some examples, the MCQ ID may occupy five bits of the IID and EXT_IID, such as bits [3:0] of the IID and bit 4 of the EXT_IID. In some cases, the MCQ ID may support the memory system 110 identifying a storage location for storing data included in the UPIU, for example due to data associated with the same MCQ ID being managed within a similar region of memory according to a locality principle. For example, the MCQ ID may indicate that data for a given host process is to be stored and managed (e.g., in accordance with memory management operations) in a physical location with other data associated with the same host process. In such examples, the data in the physical location may be managed similarly, such as being refreshed collectively, or being relocated collectively (e.g., as part of media management operations such as garbage collection or wear leveling) regardless of whether the data is written in accordance with a sequential write operation (e.g., without an explicit indication that data from a same host process is sequential data). Thus, various sets of data for a given host process may be managed collectively, which may improve access efficiency even when such sets of data are not sequential.

In some implementations, a host system 105 may additionally, or alternatively, include information related to a storage configuration for storing data in a second set of one or more bits of the IID and EXT_IID fields (e.g., bits [7:5] of the EXT_IID), where the second set of one or more bits may include respective flags indicating a status of the data. For example, a HP flag may be associated with a first bit of the second set of one or more bits and may indicate whether the data is to be written to a SLC cache. A SD flag may be associated with a second bit of the second set of one or more bits and may indicate whether the data is to be written to a region associated with reduced write amplification or high endurance. A DC flag may be associated with a third bit of the second set of one or more bits and may indicate whether the data is hot data or cold data (e.g., indicating whether the data should be stored to blocks with relatively higher or lower PEC counts). By utilizing the IID and EXT_IID fields of a UPIU associated with a write command to indicate storage configurations for storing data, performance of a memory system 110 when executing the write command, or subsequent read commands or media management operations, may be improved (e.g., enabling the memory system to meet TBW constraints associated with an automotive usage scenario).

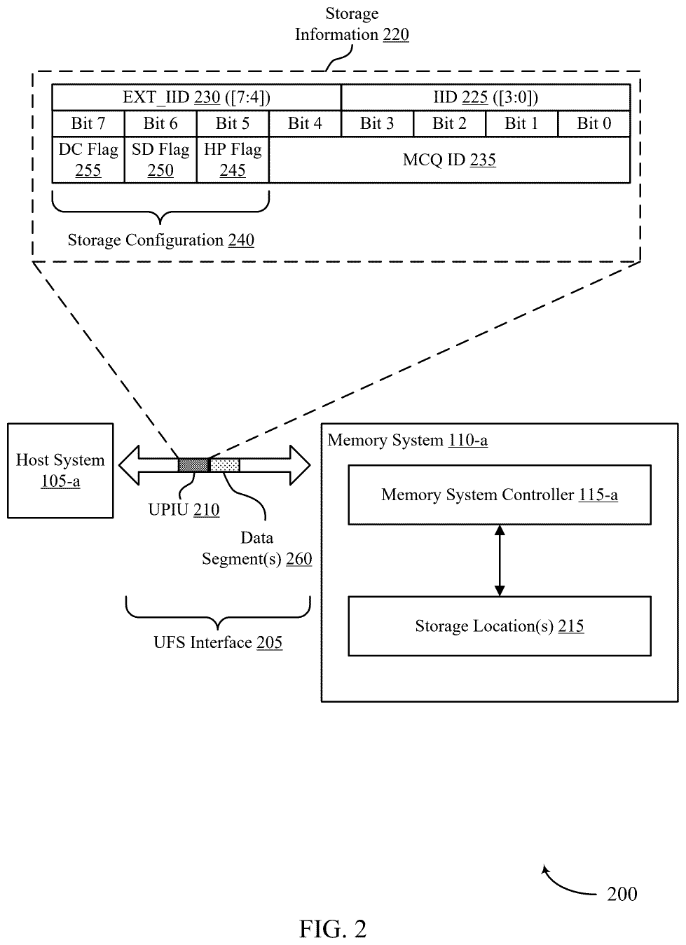

FIG. 2 shows an example of a system 200 that supports status indications for storing data to a memory system via command headers in accordance with examples as disclosed herein. The system 200 may implement, or be implemented by, one or more aspects of the system 100. For example, the system 200 may include a host system 105-a and a memory system 110-a. The system 200 may support the host system 105-a and the memory system 110-a transferring data or otherwise communicating via an interface, such as a UFS interface 205. For example, the host system 105-a may transmit, to the memory system 110-a via the UFS interface 205, a UPIU 210 and one or more data segments 260, which may be associated with (e.g., correspond to, accompany, include, be included in) a command to write data (e.g., data included in the one or more data segments 260) to the memory system 110-a. In accordance with techniques described herein, the memory system 110-a may store the data to one or more storage locations 215 (e.g., physical region(s) of memory located in one or more memory devices 130 of the memory system 110-a) according to storage information 220 included in one or more header segments of the UPIU 210, such as information indicated via an IID field 225 and an EXT_IID field 230 of the UPIU 210.

In some examples, a UPIU 210 may include one or more header segments. For example, a first 12 bytes of the UPIU 210 may correspond to the one or more header segments, and may include information (e.g., configuration information, storage information, control information, a write configuration) that configures the memory system 110-a for executing a command associated with the UPIU 210. The information may include the IID field 225 and the EXT_IID field 230 at designated bytes within the one or more header segments of the UPIU 210. For example, the IID field 225 may correspond to a portion of a first byte in the one or more header segments (e.g., bits [3:0] of byte 4) and the EXT_IID field 230 may correspond to a portion of a second byte in the one or more header segments (e.g., bits [7:4] of byte 7). In some cases, the memory system controller 115-a may receive the IID field 225 and the EXT_IID field 230 such that, when combined together (e.g., aggregated, appended), the memory system controller 115-a identifies a continuous set of bits corresponding to the storage information 220 (e.g., the IID field 225 and the EXT_IID field 230 may form one byte or some other quantity of bits that indicate the storage information 220).

The storage information 220 may include a first set of one or more bits corresponding to an MCQ ID 235. For example, the MCQ ID 235 may be included within the IID field 225 and a first portion of the EXT_IID field 230 (e.g., bits [3:0] of the IID field 225 and bit 4 of the EXT_IID field 230). The MCQ ID 235 may indicate a host process (e.g., a process identifier of a process at the host system 105-a) associated with the UPIU 210, where requests associated with the same upper-layer process may be assigned the same MCQ ID and, in some examples, may be handled by the same CPU core or set of multiple CPU cores of the host system 105-a (e.g., a first CPU core of multiple CPU cores of the host system 105-a). In some examples, the memory system controller 115-a may identify one or more storage locations 215, or a portion of a storage location 215, for storing data included in the one or more data segments 260 (e.g., included as part of the UPIU 210 or communicated alongside the UPIU 210) according to the MCQ ID 235. For example, such techniques may support storing data in accordance with a locality principle, such as storing data with the same MCQ ID in the same portion of memory (e.g., due to data from the same process being likely to be sequential or otherwise related).

For example, the memory system controller 115-a may store data in a same physical region of memory (e.g., a same set of one or more blocks 170, of a configured storage location 215) when the data is associated with the same MCQ ID, such that data associated with the same host process may be managed together during internal firmware data movement (e.g., media management operations such as garbage collection, wear leveling, refresh, or the like) and may benefit from improved read performance, among other accessing and management. In some cases, in response to the UPIU 210 indicating the MCQ ID 235, the memory system controller 115-a may identify that a storage location 215 (e.g., a physical region of memory) stores second data associated with the MCQ ID 235, and may determine to store the data of the UPIU 210 to the storage location 215 due to the locality principle. It should be noted that the memory system 110-a may include any quantity of storage locations 215 each including any quantity of memory cells (e.g., any quantity of blocks 170), and is not limited to the example illustrated by the system 200. For example, the memory system controller 115-a (e.g., according to UFS firmware of the memory system 110-a) may separately prepare and open different sets of one or more memory blocks 170 for data having different MCQ ID values, which may correspond to multiple different storage locations 215 located among one or more memory devices of the memory system 110-a.

In some examples, the storage information 220 may include a second set of one or more bits corresponding to a storage configuration 240 for storing the data included in the one or more data segments 260. For example, the second set of one or more bits may be located within a portion of the EXT_IID field 230 (e.g., bits [7:5] of the EXT_IID field 230) and may include one or more flags indicating a respective status of the data. In some examples, a respective value of each bit in the second set of one or more bits may indicate the storage configuration 240 (e.g., the second set of one or more bits may be able to indicate multiple storage configurations 240 according to different combinations of status flag values). The storage configuration 240 may support the memory system controller 115-a determining a configuration (e.g., type, storage density, access characteristic) of memory to store the data to (e.g., a type of memory associated with the storage location 215 or a portion of the storage location 215) according to the values of the status flags. Additionally, the bits of the storage configuration 240 may be included at any bit index within the storage information 220 or the one or more header segments of the UPIU 210, and are not limited to the indices illustrated by the system 200.

A first bit of the storage configuration 240 may correspond to a HP flag 245 (e.g., bit 5 of the EXT_IID field 230), which may indicate whether the data is high performance data. To indicate that the data is high performance data, the host system 105-a may set the HP flag 245 in the UPIU 210 to a first value (e.g., a set value, which may be configured binary 1 or binary 0) indicating that the data is to be handled in accordance with high performance operations (e.g., high throughput, low latency). In some examples, when the memory system 110-a receives the UPIU 210 including the HP flag 245 set to the first value, the memory system controller 115-a may determine to store the data to an internal fast cache area (e.g., similar to a write boost operation). For example, the configured storage location 215, or portion thereof, for writing the data may be a set of SLCs (e.g., an SLC cache) when the HP flag 245 is set to the first value.

A second bit of the storage configuration 240 may correspond to a SD flag 250 (e.g., bit 6 of the EXT_IID field 230), which may indicate whether the data is high-stress data. To indicate that the data is high-stress data, the host system 105-a may set the SD flag 250 in the UPIU 210 to the first value, such as when the data is associated with stream recording. In some examples, when the memory system 110-a receives the UPIU 210 including the SD flag 250 set to the first value, the memory system controller 115-a may determine to store the data to an area of memory associated with a relatively low write amplification factor, relatively high endurance, or both (e.g., according to NAND capability and UFS firmware implementation at the memory system 110-a). For example, the memory system controller 115-a may achieve a lower write amplification factor by writing the data (directly, bypassing an SLC cache) to an array of multiple-level memory cells (e.g., the configured storage location 215, or portion thereof, may be an array of TLCs, QLCs, or any other type of memory cell capable of conveying multiple bits of information). As another example, the memory system controller 115-a may write the data to high-endurance memory (e.g., the storage location 215 may be associated with high endurance memory) including memory cells having relatively larger PEC capability, such that the memory system 110-a may balance a tradeoff between PEC endurance and write performance or data retention capability.

A third bit of the storage configuration 240 may correspond to a DC flag 255 (e.g., bit 7 of the EXT_IID field 230), which may indicate whether the data is hot data or cold data. To indicate that the data is cold data, the host system 105-a may set the DC flag 255 to the first value and to indicate that the data is hot data, the host system 105-a may set the DC flag 255 to a second value different from the first value (e.g., binary 1 may indicate cold data and binary 0 may indicate hot data, or vice versa). In some examples, when the memory system 110-a receives the UPIU 210 including the DC flag 255 set to the first value, the memory system controller 115-a may determine to store the data to physical NAND blocks having relatively high PEC counts. For example, in accordance with a dynamic wear leveling algorithm (e.g., due to cold data being associated with a reduced access frequency), the memory system controller 115-a may store the data to one or more blocks 170 of NAND memory cells having a PEC count that satisfies (e.g., is greater than or equal to) a threshold. Alternatively, when the memory system 110-a receives the UPIU 210 including the DC flag 255 set to the second value, the memory system controller 115-a may determine to store the data to physical NAND blocks having relatively low PEC counts. For example, in accordance with the dynamic wear leveling algorithm (e.g., due to hot data being associated with an increased access frequency), the memory system controller 115-a may store the data to one or more blocks 170 of NAND memory cells having a PEC count that does not satisfy (e.g., is less than) the threshold. In some examples, the threshold may be determined according to the dynamic wear leveling algorithm and may be set relative to PEC counts of other NAND blocks of the memory system 110-a, such as being set relative to an average PEC count across the NAND blocks.

Thus, in accordance with these and other examples, a host system 105 and a memory system 110 can be configured to utilize a UPIU 210 associated with a write command to indicate information (e.g., storage information 220) for storing data associated with the UPIU. For example, the storage information 220 may indicate an MCQ ID 235 and a storage configuration 240, which may provide a memory system 110-a with information associated with storing data included in one or more data segments 260 associated with the UPIU 210. The MCQ ID 235 and the storage configuration 240 may support the memory system 110 determining one or more storage location(s) 215 for storing the data, such as by indicating a physical area of memory associated with the MCQ ID 235 and a configuration associated with the physical area of memory (e.g., via the storage configuration 240). Such techniques may improve performance of a memory system 110 when executing the write command, or subsequent read commands or media management operations, compared to other techniques that do not include such indications.

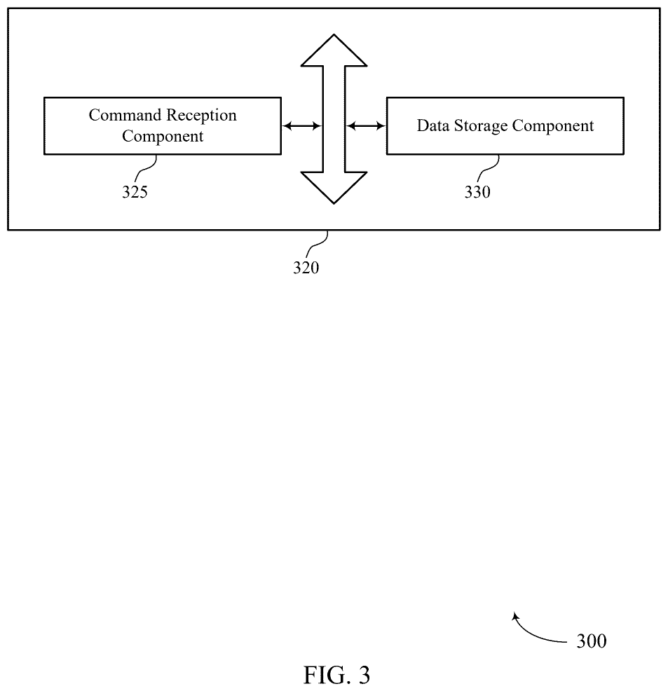

FIG. 3 shows a block diagram 300 of a memory system 320 that supports status indications for storing data to a memory system via command headers in accordance with examples as disclosed herein. The memory system 320 may be an example of aspects of a memory system as described with reference to FIGS. 1 through 2. The memory system 320, or various components thereof, may be an example of means for performing various aspects of status indications for storing data to a memory system via command headers as described herein. For example, the memory system 320 may include a command reception component 325, a data storage component 330, or any combination thereof. Each of these components, or components of subcomponents thereof (e.g., one or more processors, one or more memories), may communicate, directly or indirectly, with one another (e.g., via one or more buses).

The command reception component 325 may be configured as or otherwise support a means for receiving (e.g., at the memory system 320) a write command including one or more header segments and one or more data segments, the one or more header segments including a first set of one or more bits corresponding to a host process associated with the write command and a second set of one or more bits corresponding to one or more storage configurations for storing data included in the one or more data segments. The data storage component 330 may be configured as or otherwise support a means for storing, in response to receiving the write command and based on the second set of one or more bits, the data of the one or more data segments to a storage location of one or more memory devices of the memory system 320 determined based on the first set of one or more bits.

In some examples, the write command includes a UPIU, and the one or more header segments include an IID field and an extended IID field in accordance with the UPIU.

In some examples, the first set of one or more bits are located within the IID field and a first portion of the extended IID field and the second set of one or more bits are located within a second portion of the extended IID field.

In some examples, to support storing the data, the data storage component 330 may be configured as or otherwise support a means for storing the data to a set of single-level memory cells of the memory system 320 in response to a first bit of the second set of one or more bits corresponding to whether the data is high performance data.

In some examples, to support storing the data, the data storage component 330 may be configured as or otherwise support a means for storing the data to a location of the memory system 320 associated with a low write amplification factor in response to a second bit of the second set of one or more bits corresponding to whether the data is high-stress data.

In some examples, to support storing the data, the data storage component 330 may be configured as or otherwise support a means for storing the data to one or more blocks of NAND memory cells of the memory system 320 having a program/erase cycle count that satisfies a threshold in response to a third bit of the second set of one or more bits corresponding to whether the data is cold data.

In some examples, to support storing the data, the data storage component 330 may be configured as or otherwise support a means for storing the data in a physical location with second data associated with the host process.

In some examples, the first set of one or more bits indicate a CPU core of a plurality of CPU cores of a host system.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

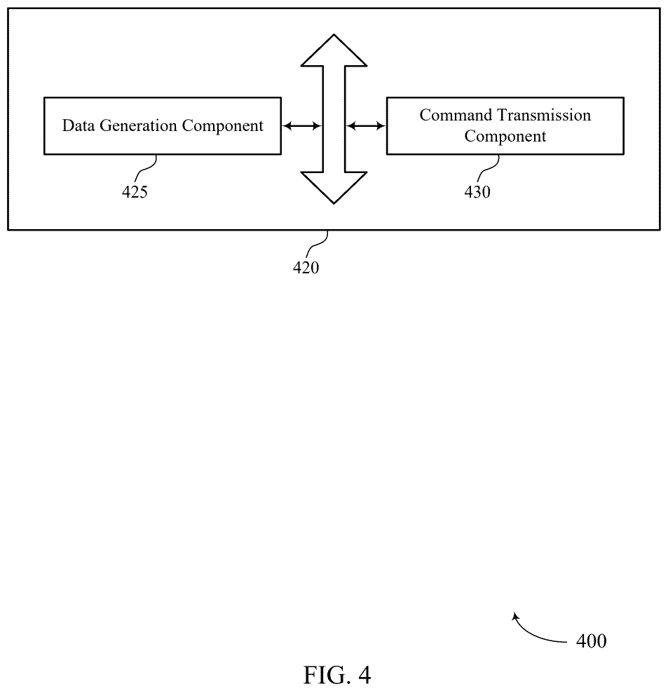

FIG. 4 shows a block diagram 400 of a host system 420 that supports status indications for storing data to a memory system via command headers in accordance with examples as disclosed herein. The host system 420 may be an example of aspects of a host system as described with reference to FIGS. 1 through 2. The host system 420, or various components thereof, may be an example of means for performing various aspects of status indications for storing data to a memory system via command headers as described herein. For example, the host system 420 may include a data generation component 425 a command transmission component 430, or any combination thereof. Each of these components, or components of subcomponents thereof (e.g., one or more processors, one or more memories), may communicate, directly or indirectly, with one another (e.g., via one or more buses).

The data generation component 425 may be configured as or otherwise support a means for determining data to be stored at a memory system. In some examples, the data generation component 425 may be configured as or otherwise support a means for determining a host process associated with the data. The command transmission component 430 may be configured as or otherwise support a means for transmitting (e.g., from the host system 420) a write command including one or more header segments and one or more data segments, the one or more header segments including a first set of one or more bits corresponding to the host process associated with the data and a second set of one or more bits corresponding to one or more storage configurations for storing the data.

In some examples, the write command includes a UPIU, and the one or more header segments include an IID field and an extended IID field in accordance with the UPIU.

In some examples, the first set of one or more bits are located within the IID field and a first portion of the extended IID field and the second set of one or more bits are located within a second portion of the extended IID field.

In some examples, a value of a first bit of the second set of one or more bits indicates to store the data to a set of single-level memory cells of the memory system based on the data being high performance data.

In some examples, a value of a second bit of the second set of one or more bits indicates to store the data to a location of the memory system associated with a low write amplification factor based on the data being stressful data.

In some examples, a value of a third bit of the second set of one or more bits indicates to store the data to one or more blocks of NAND memory cells of the memory system having a program/erase cycle count that satisfies a threshold value based on the data being cold data.

In some examples, determining the host process associated with the data is based on determining a CPU core, from a plurality of CPU cores of the host system 420, associated with the write command.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 420, or various components thereof, may be implemented at least in part by instructions (e.g., stored in memory, non-transitory computer-readable medium) executable by such at least one processor.

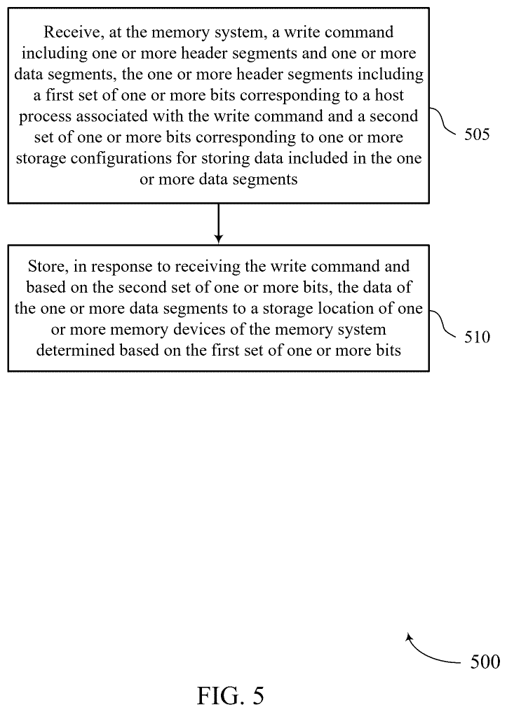

FIG. 5 shows a flowchart illustrating a method 500 that supports status indications for storing data to a memory system via command headers in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving, at the memory system, a write command including one or more header segments (e.g., of or associated with a UPIU 210, an EXT_IID field 230, an IID field 225) and one or more data segments (e.g., a data segment 260), the one or more header segments including a first set of one or more bits (e.g., an MCQ ID 235) corresponding to a host process associated with the write command and a second set of one or more bits (e.g., of a storage configuration 240, a DC Flag 255, an SD Flag 250, an HP Flag 245) corresponding to one or more storage configurations for storing data included in the one or more data segments. In some examples, aspects of the operations of 505 may be performed by a command reception component 325 as described with reference to FIG. 3. For example, the memory system may include the command reception component 325 that receives the write command (e.g., the UPIU 210 of FIG. 2) indicating the one or more storage configurations (e.g., the storage configuration 240 of FIG. 2) for storing data included in the write command—e.g., as described herein, including with reference to the operations described in FIG. 2.

At 510, the method may include storing, in response to receiving the write command and based on the second set of one or more bits, the data of the one or more data segments to a storage location (e.g., a storage location 215) of one or more memory devices of the memory system determined based on the first set of one or more bits. In some examples, aspects of the operations of 510 may be performed by a data storage component 330 as described with reference to FIG. 3. For example, the memory system may include the data storage component 330 that stores the data to a storage location (e.g., the storage location 215 of FIG. 2) determined based on the first set of one or more bits—e.g., as described herein, including with reference to the operations described in FIG. 2.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at the memory system, a write command including one or more header segments and one or more data segments, the one or more header segments including a first set of one or more bits corresponding to a host process associated with the write command and a second set of one or more bits corresponding to one or more storage configurations for storing data included in the one or more data segments and storing, in response to receiving the write command and based on the second set of one or more bits, the data of the one or more data segments to a storage location of one or more memory devices of the memory system determined based on the first set of one or more bits.

Aspect 2: The method, apparatus, or non-transitory computer-readable medium of aspect 1, where the write command includes a UPIU, and the one or more header segments include an IID field and an extended IID field in accordance with the UPIU.

Aspect 3: The method, apparatus, or non-transitory computer-readable medium of aspect 2, where the first set of one or more bits are located within the IID field and a first portion of the extended IID field and the second set of one or more bits are located within a second portion of the extended IID field.

Aspect 4: The method, apparatus, or non-transitory computer-readable medium of any of aspects 1 through 3, where storing the data includes operations, features, circuitry, logic, means, or instructions, or any combination thereof for storing the data to a set of single-level memory cells of the memory system in response to a first bit of the second set of one or more bits corresponding to whether the data is high performance data.

Aspect 5: The method, apparatus, or non-transitory computer-readable medium of any of aspects 1 through 4, where storing the data includes operations, features, circuitry, logic, means, or instructions, or any combination thereof for storing the data to a location of the memory system associated with a low write amplification factor in response to a second bit of the second set of one or more bits corresponding to whether the data is high-stress data.

Aspect 6: The method, apparatus, or non-transitory computer-readable medium of any of aspects 1 through 5, where storing the data includes operations, features, circuitry, logic, means, or instructions, or any combination thereof for storing the data to one or more blocks of NAND memory cells of the memory system having a program/erase cycle count that satisfies a threshold in response to a third bit of the second set of one or more bits corresponding to whether the data is cold data.

Aspect 7: The method, apparatus, or non-transitory computer-readable medium of any of aspects 1 through 6, where storing the data includes operations, features, circuitry, logic, means, or instructions, or any combination thereof for storing the data in a physical location with second data associated with the host process.

Aspect 8: The method, apparatus, or non-transitory computer-readable medium of any of aspects 1 through 7, where the first set of one or more bits indicate a CPU core of a plurality of CPU cores of a host system.

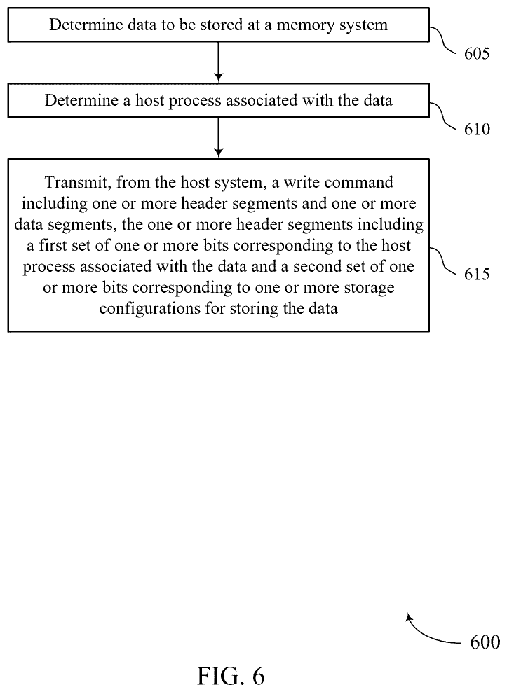

FIG. 6 shows a flowchart illustrating a method 600 that supports status indications for storing data to a memory system via command headers in accordance with examples as disclosed herein. The operations of method 600 may be implemented by a host system or its components as described herein. For example, the operations of method 600 may be performed by a host system as described with reference to FIGS. 1 through 2 and 4. In some examples, a host system may execute a set of instructions to control the functional elements of the device to perform the described functions. Additionally, or alternatively, the host system may perform aspects of the described functions using special-purpose hardware.

At 605, the method may include determining data to be stored at a memory system. In some examples, aspects of the operations of 605 may be performed by a data generation component 425 as described with reference to FIG. 4. For example, the host system may include the data generation component 425 at a host system controller (e.g., a host system controller included in the host system 105-a of FIG. 2).

At 610, the method may include determining a host process associated with the data. In some examples, aspects of the operations of 610 may be performed by a data generation component 425 as described with reference to FIG. 4. For example, the host system may include the data generation component 425 at a host system controller (e.g., a host system controller included in the host system 105-a of FIG. 2), which may determine one or more CPU cores and/or a process identifier associated with the data to be stored at the memory system (e.g., to leverage a locality principle).

At 615, the method may include transmitting, from the host system, a write command including one or more header segments (e.g., of or associated with a UPIU 210, an EXT_IID field 230, an IID field 225) and one or more data segments (e.g., a data segment 260), the one or more header segments including a first set of one or more bits (e.g., an MCQ ID 235) corresponding to the host process associated with the data and a second set of one or more bits (e.g., of a storage configuration 240, a DC Flag 255, an SD Flag 250, an HP Flag 245) corresponding to one or more storage configurations for storing the data. In some examples, aspects of the operations of 615 may be performed by a command transmission component 430 as described with reference to FIG. 4. For example, the host system may include the command transmission component 430 that transmits the write command (e.g., the UPIU 210 of FIG. 2) indicating the one or more storage configurations (e.g., the storage configuration 240 of FIG. 2).

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for determining data to be stored at a memory system; determining a host process associated with the data; and transmitting, from the host system, a write command including one or more header segments and one or more data segments, the one or more header segments including a first set of one or more bits corresponding to the host process associated with the data and a second set of one or more bits corresponding to one or more storage configurations for storing the data.

Aspect 10: The method, apparatus, or non-transitory computer-readable medium of aspect 9, where the write command includes a UPIU, and the one or more header segments include an IID field and an extended IID field in accordance with the UPIU.

Aspect 11: The method, apparatus, or non-transitory computer-readable medium of aspect 10, where the first set of one or more bits are located within the IID field and a first portion of the extended IID field and the second set of one or more bits are located within a second portion of the extended IID field.

Aspect 12: The method, apparatus, or non-transitory computer-readable medium of any of aspects 9 through 11, where a value of a first bit of the second set of one or more bits indicates to store the data to a set of single-level memory cells of the memory system based on the data being high performance data.

Aspect 13: The method, apparatus, or non-transitory computer-readable medium of any of aspects 9 through 12, where a value of a second bit of the second set of one or more bits indicates to store the data to a location of the memory system associated with a low write amplification factor based on the data being stressful data.

Aspect 14: The method, apparatus, or non-transitory computer-readable medium of any of aspects 9 through 13, where a value of a third bit of the second set of one or more bits indicates to store the data to one or more blocks of NAND memory cells of the memory system having a program/erase cycle count that satisfies a threshold value based on the data being cold data.

Aspect 15: The method, apparatus, or non-transitory computer-readable medium of any of aspects 9 through 14, where determining the host process associated with the data is based on determining a CPU core, from a plurality of CPU cores of the host system, associated with the write command.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command comprising one or more header segments and one or more data segments, the one or more header segments comprising a first set of one or more bits corresponding to a host process associated with the write command and a second set of one or more bits corresponding to one or more storage configurations for storing data included in the one or more data segments; and
store, in response to receiving the write command and based on the second set of one or more bits, the data of the one or more data segments to a storage location of the one or more memory devices determined based on the first set of one or more bits.

2. The memory system of claim 1, wherein the write command comprises a universal flash storage (UFS) protocol information unit (UPIU), and the one or more header segments comprise an initiator identifier (IID) field and an extended IID field in accordance with the UPIU.

3. The memory system of claim 2, wherein the first set of one or more bits are located within the IID field and a first portion of the extended IID field and the second set of one or more bits are located within a second portion of the extended IID field.

4. The memory system of claim 1, wherein, to store the data, the processing circuitry is configured to cause the memory system to:
store the data to a set of single-level memory cells of the one or more memory devices in response to a first bit of the second set of one or more bits corresponding to whether the data is high performance data.

5. The memory system of claim 1, wherein, to store the data, the processing circuitry is configured to cause the memory system to:
store the data to a location of the one or more memory devices associated with a low write amplification factor in response to a second bit of the second set of one or more bits corresponding to whether the data is high-stress data.

6. The memory system of claim 1, wherein, to store the data, the processing circuitry is configured to cause the memory system to:
store the data to one or more blocks of NAND memory cells of the one or more memory devices having a program/erase cycle count that satisfies a threshold in response to a third bit of the second set of one or more bits corresponding to whether the data is cold data.

7. The memory system of claim 1, wherein, to store the data, the processing circuitry is configured to cause the memory system to:
store the data in a physical location with second data associated with the host process.

8. The memory system of claim 1, wherein the first set of one or more bits indicate a central processing unit (CPU) core of a plurality of CPU cores of a host system.

9. A host system, comprising:
one or more interfaces comprising one or more signal paths operable for communications with one or more memory systems; and
processing circuitry coupled with the one or more interfaces and configured to cause the host system to:
determine data to be stored at a memory system;
determine a host process associated with the data; and
transmit, from the host system, a write command comprising one or more header segments and one or more data segments, the one or more header segments comprising a first set of one or more bits corresponding to the host process associated with the data and a second set of one or more bits corresponding to one or more storage configurations for storing the data.

10. The host system of claim 9, wherein the write command comprises a universal flash storage (UFS) protocol information unit (UPIU), and the one or more header segments comprise an initiator identifier (IID) field and an extended IID field in accordance with the UPIU.

11. The host system of claim 10, wherein the first set of one or more bits are located within the IID field and a first portion of the extended IID field and the second set of one or more bits are located within a second portion of the extended IID field.

12. The host system of claim 9, wherein a value of a first bit of the second set of one or more bits indicates to store the data to a set of single-level memory cells of the memory system based on the data being high performance data.

13. The host system of claim 9, wherein a value of a second bit of the second set of one or more bits indicates to store the data to a location of the memory system associated with a low write amplification factor based on the data being stressful data.

14. The host system of claim 9, wherein a value of a third bit of the second set of one or more bits indicates to store the data to one or more blocks of NAND memory cells of the memory system having a program/erase cycle count that satisfies a threshold value based on the data being cold data.

15. The host system of claim 9, wherein determining the host process associated with the data is based on determining a central processing unit (CPU) core, from a plurality of CPU cores of the host system, associated with the write command.

16. A method by a memory system, comprising:
receiving, at the memory system, a write command comprising one or more header segments and one or more data segments, the one or more header segments comprising a first set of one or more bits corresponding to a host process associated with the write command and a second set of one or more bits corresponding to one or more storage configurations for storing data included in the one or more data segments; and
storing, in response to receiving the write command and based on the second set of one or more bits, the data of the one or more data segments to a storage location of one or more memory devices of the memory system determined based on the first set of one or more bits.

17. The method of claim 16, wherein the write command comprises a universal flash storage (UFS) protocol information unit (UPIU), and the one or more header segments comprise an initiator identifier (IID) field and an extended IID field in accordance with the UPIU.

18. The method of claim 17, wherein the first set of one or more bits are located within the IID field and a first portion of the extended IID field and the second set of one or more bits are located within a second portion of the extended IID field.

19. The method of claim 16, wherein storing the data comprises:
storing the data to a set of single-level memory cells of the memory system in response to a first bit of the second set of one or more bits corresponding to whether the data is high performance data.

20. The method of claim 16, wherein storing the data comprises:
storing the data to a location of the memory system associated with a low write amplification factor in response to a second bit of the second set of one or more bits corresponding to whether the data is high-stress data.
